(19) United States
(12) Patent Application Publication
(10) Pub. No.: US 2025/0187151 A1
(43) Pub. Date: Jun. 12, 2025

(54) ADAPTABLE VACUUM CLAMPING AND POD SYSTEM FOR CNC ROUTER APPLICATION

(71) Applicant: VersaPod Inc., Center Valley, PA (US)

(72) Inventors: Michael Shepler, Mechanicsburg, PA (US); Chun Wai Hung, Camp Hill, PA (US)

(73) Assignee: VersaPod Inc., Center Valley, PA (US)

(21) Appl. No.: 18/971,956

(22) Filed: Dec. 6, 2024

Related U.S. Application Data
(60) Provisional application No. 63/607,929, filed on Dec. 8, 2023.

(51) Int. Cl. B25B 11/00

(52) U.S. Cl. CPC B25B 11/005

(57) ABSTRACT

A versatile pod system configured for use with a CNC machines and robot arm operations includes: a grid and pod platform base assembly configured for attachment to a vacuum system and capable of drawing a vacuum therethrough; a vacuum pod that engages the grid and pod platform base assembly; and a marker holder assembly that holds a marker and mark the grid and platform base assembly with an outline in a desired shape.

### BACKGROUND

When using Computer Numerical Control (CNC) routers, it is common to use a vacuum table to hold the workpiece to be shaped. A vacuum table uses a vacuum pump to create a suction force that holds the workpiece firmly against the table's surface. This method of work holding offers several advantages:

Secure Clamping: Vacuum tables provide uniform and secure clamping over the entire surface of the workpiece, ensuring that it doesn't move or shift during machining. This is especially important for precision cutting and milling operations.

Minimal Material Damage: Unlike traditional clamping methods like screws or clamps, vacuum tables don't leave visible marks or indentations on the workpiece's surface, which can be important for materials with sensitive finishes or appearances.

Versatility: Vacuum tables can accommodate a wide range of workpiece sizes and shapes, as long as they create an effective seal with the table surface. This makes them versatile for various CNC routing applications.

Reduced Setup Time: Setting up a workpiece on a vacuum table is often quicker and more straightforward than traditional clamping methods, which can save time and improve efficiency in production environments.

To use a vacuum table effectively, CNC operators create and use dedicated fixtures (which match the shape and size of their workpieces), a spoil board system, or use expensive “pod and rail” or “grid aligned pods.” Pod systems and highly engineered dedicated fixtures allow for machining to the sides and undercuts on the workpiece. These fixtures include gaskets between the table and the workpiece to create a seal with the vacuum table, ensuring a strong hold. Once aligned, a user activates a vacuum pump to create the suction force, securely holding the workpiece in place for the duration of the machining process.

One of the challenges in working with CNC routers and workpieces is switching between workpiece shapes, as each new shape requires a new setup on the table. Balancing holding force, cost/time, and ease of setup/changeover is nuanced. And it is difficult to effectively conduct vacuum through an array of ports with flush-fitting, individually controllable valves on the CNC tabletop (“port board”) to allow unrestricted placement of vacuum pods, accurate z-axis positioning, and unobstructed use of a “Dry-Erase Marking System.” and with a pod base surface finish and material to ensure easy erasure of dry-erase marks. This poses a challenge for smaller manufacturers, or manufacturers with more custom workpieces, even large manufacturer may benefit from more economical and versatile workpiece holding.

### SUMMARY OF THE EMBODIMENTS

A versatile pod system configured for use with a CNC machines and robot arm operations includes: a grid and pod platform base assembly configured for attachment to a vacuum system and capable of drawing a vacuum therethrough; a vacuum pod configured to engage the grid and pod platform base assembly; and a marker holder assembly configured to hold a marker and mark the grid and platform base assembly with an outline in a desired shape.

A non-porous sheet with a grid pattern milled into one side, overlayed with a non-porous, dry-erase marker compatible sheet, which may include holes to conduct the vacuum from a grid table to chosen locations. This overlaid sheet, “port board,” effectively conducts vacuum through an array of ports with flush-fitting, individually controllable valves, allowing unrestricted placement of vacuum pods, accurate z-axis positioning, and unobstructed use of the “Dry-Erase Marking System” (other valve options may be a custom plug or spring-loaded valve). A dry-erase marker holder for CNC application marks the parts' placement (or pod placement)/alignment shapes on the port board. A user or machine removes film (or punctures the film, or opens valve of other type) within the marked shapes where pods and parts are to be placed. Once placed, the vacuum table introduces the vacuum through the underlying grid to grasp the pod and workpiece against the port board.

### BRIEF DESCRIPTION OF THE DRAWINGS

FIG. 1 shows an overview of the pod system components.

FIG. 2 shows pod design variations.

FIG. 3 shows the platform base assembly's main components.

FIG. 3A is a cross-section through the vacuum grid base along line 3A-3A.

FIG. 4 shows a marker holder assembly.

FIGS. 5-11, with an optional step in FIG. 12, show an overview of the method of using the system, where FIG. 10B is a section through FIG. 10A. FIG. 10C shows an alternate embodiment of FIG. 10B.

FIG. 13A shows a bottom view of an alternate platform base assembly, where FIG. 13B is a section through lines 13B-13B in FIG. 13A. FIG. 13C shows a detail view of FIG. 13B.

### DETAILED DESCRIPTION OF THE EMBODIMENTS

The versatile pod system 100 described herein overlays on a machine bed 510 for a CNC machine (or robot arm workstation) 500. The versatile pod system 500 may overlay the CNC bed in whole or in part, and may be secured thereto with permanent or removable connections, which may include bolts, clamps, adhesive, or the like. The CNC machine 500 may include CNC machine arm(s) 520 with tool holders that hold a tool, as would be known to a person of ordinary skill in the art.

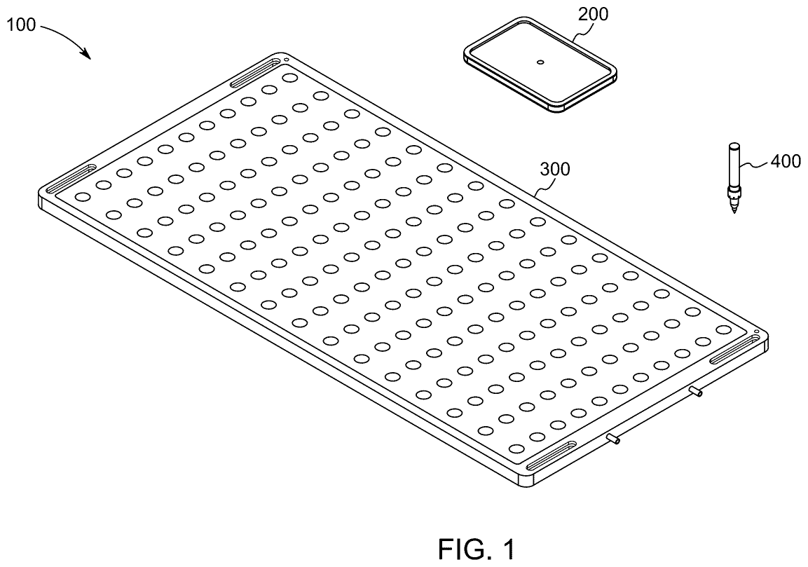

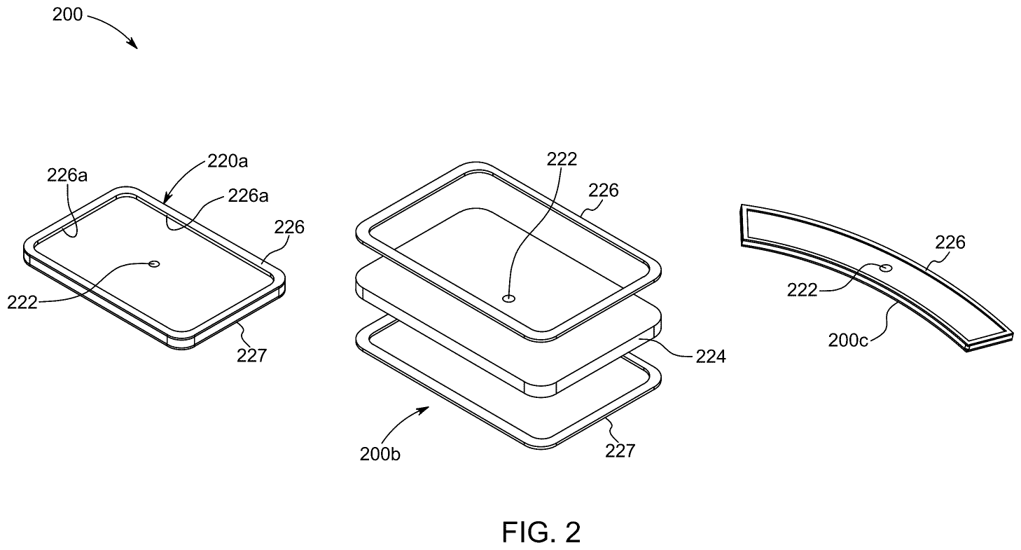

The pod system 100 may include a vacuum platform base assembly 300 where a vacuum generates negative pressure therethrough. The versatile pod system 100, shown in FIG. 1, includes at least a double-sided vacuum pod 200, a grid and pod platform base assembly 300, and a marker holder assembly 400.

FIG. 2 shows the double-side vacuum pod 200 may be of any shape, including an over-molded unitary gasket design 200a where the upper portion 226 and lower portion 227 of the gasket are a single piece, an applied foam gasket design 200b where edge gaskets 226, 227 overlay the interior body 224 that has a hole 222 therethrough that allows for passage of air, or other custom shapes like the arc design 200c. All of the pod designs share the same design of providing a sealing side (the underside of the pod 200) that faces the platform base 300 and engages the platform base 300 through its lower gasket 227. The upper gasket 227 engages a workpiece 1000. The interior body 224 gives structural shape to the pod 200, and includes a hole or air passage 222. Negative air pressure applied through the platform base 300 draws air through the air passage 222, such that when a workpiece 1000 is placed on top of the pod 200, the vacuum applied through the pod 200 holds the workpiece 1000 against the pod 200.

The edge gasket inner rim 226a (with a corresponding rim 227a on the lower gasket 227) spaces the interior body 224 from both the workpiece 1000 and the platform base 300, allowing the air to pass through the air passage 222. Without this, and without the interior body 224 being of sufficient rigidity, the pod 200 would be sucked down against the platform base 300 and no vacuum would be applied to a workpiece 1000.

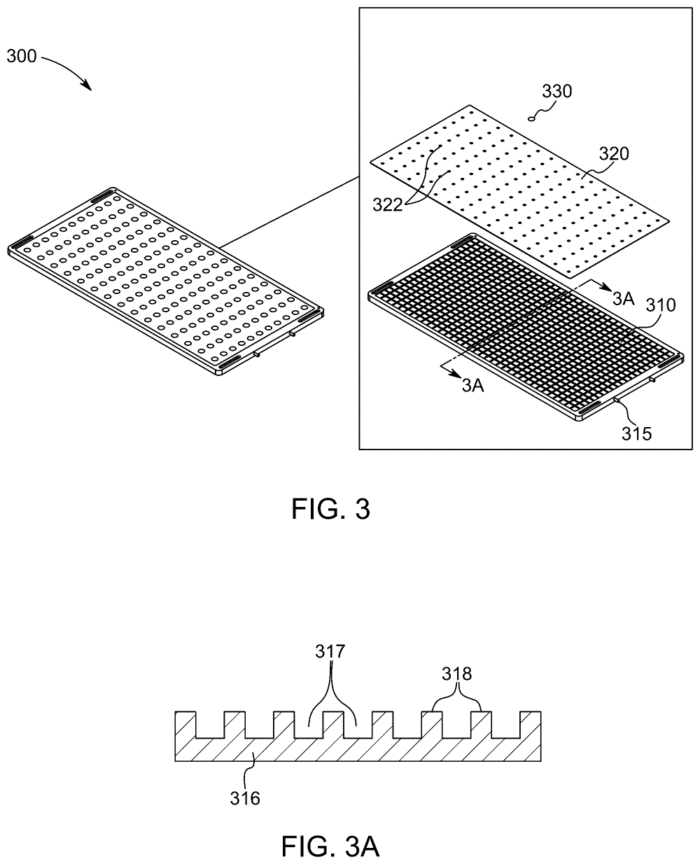

FIG. 3 shows the grid and pod platform base assembly 300 that includes several parts: a base 310 that allows for air to pass therethrough when a vacuum applied through a vacuum port 315 is creating negative pressure therethrough, a perhaps non-porous dry erase port board 320 with ports/holes 322 through a surface 324 thereof, and film valves 330 that may be circular shapes that cover the ports 322 or a complete layer of film in the shape of the port board 320, lines of film that cover each row, film that can be custom cut for removal, custom flush-fitting plugs, or spring-loaded bearing valves, or any other design that allows unrestricted placement of vacuum pods, accurate z-axis positioning, and unobstructed use of the system. The film valves 330 are substantially flush to the port board 320 (though they are shown as raised in some side views to show them clearly, this is not to scale) and may also be able to be written on and wiped off, thus also acting as a dry erase surface.

As appreciated in FIG. 3A, the vacuum base 310 includes a nonporous base 316 with spacers 318 that space the nonporous base 316 from the dry-erase port board 320 and allow for air to be drawn through the ports 322, into channels 317, and out the vacuum port 315.

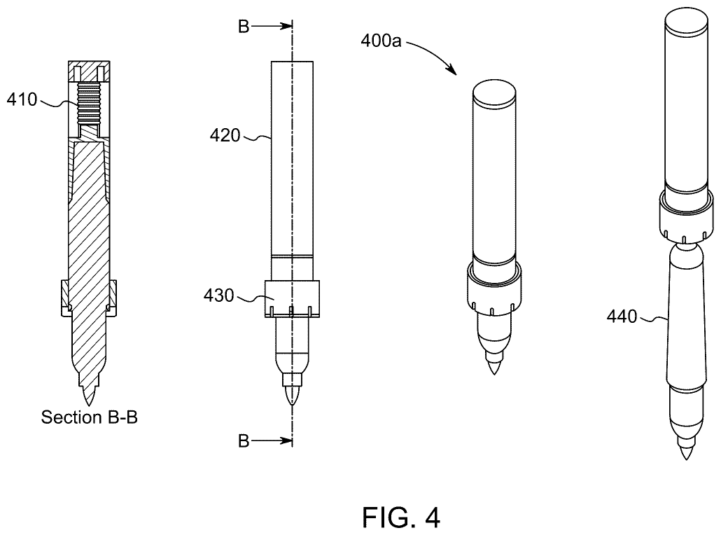

FIG. 4 shows the marker holder assembly 400 includes a spring assembly 410 that pushes lightly downwards on the marker to ensure pressure against the dry-erase port board 320, marker tube 420 that wraps around a marker 440, and a retainer tip 430 that prevents the marker from sliding out of the marker tube 420. The CNC 500 uses the marker holder assembly 400 to draw layout lines on the dry-erase port board 320 for parts and pods. The marker holder assembly 400 may fit ¼″, ½″, and ¾″ and is short enough to be used with “tool-setting” machines, and shaped such that it can be used within the control arm 520.

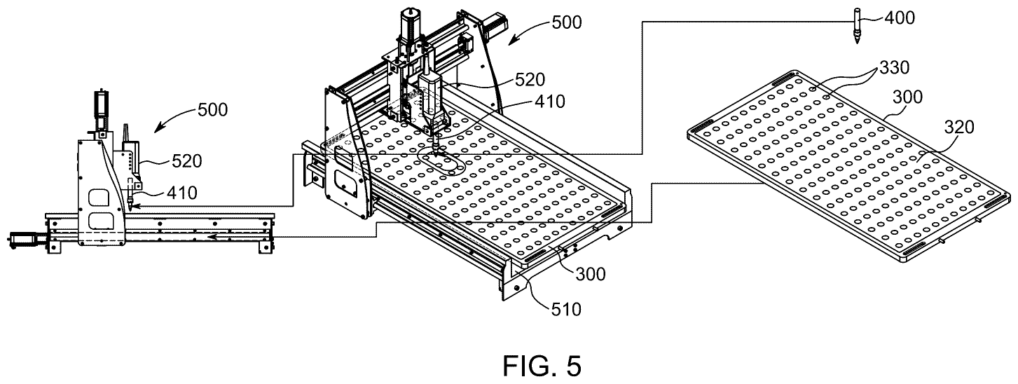

FIGS. 5-12 show the system operations steps. As a first step, a user would mount grid and pod platform base assembly 300 on the vacuum table 510 while the marker holder assembly 400 is attached to the CNC machine router or spindle 500, as shown in FIG. 5. At this point, the system would be setup and ready for use.

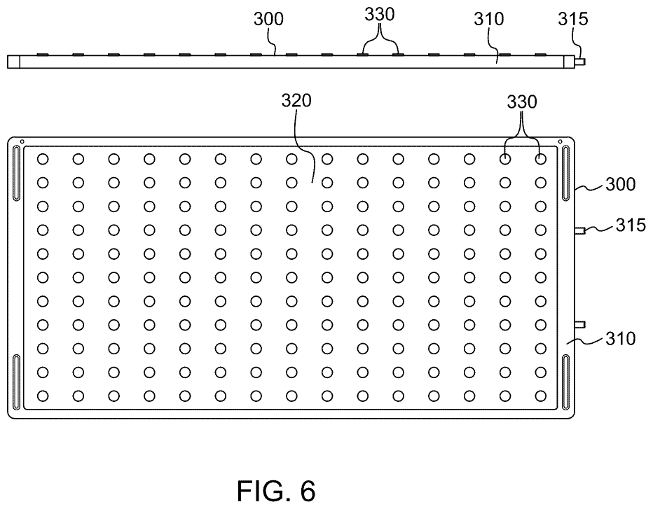

FIG. 6 shows the mounted grid and pod platform base assembly 300 with its portholes 322, all covered by film valves 330 to ensure no leakage through the platform base assembly 300, as it would be at this point. This view also shows the connections 315 for a vacuum pump. (It should be appreciated that FIGS. 5-12 do not show certain elements, including the CNC machine, for ease of presentation.)

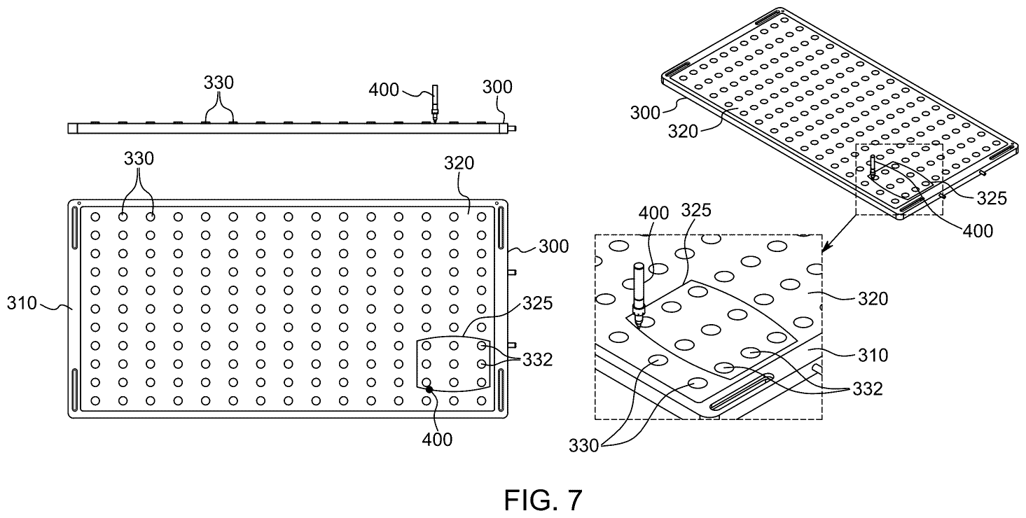

Once the platform base assembly 300 is mounted on the vacuum table 510, FIG. 7 shows how the CNC machine 500 will manipulate the marker assembly 400, using a preprogrammed shape according to a user's desire regarding their workpiece 1000, to draw a part outline 325 on the dry-erase port board 320.

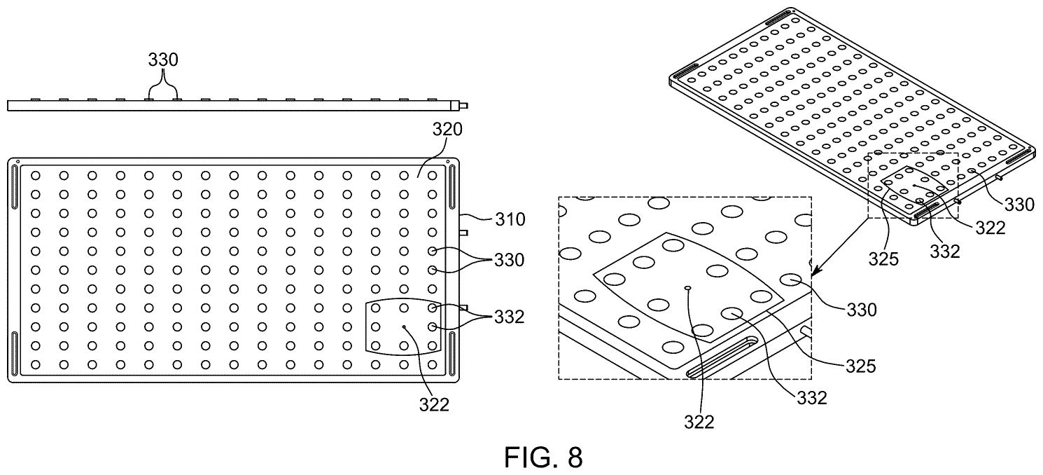

FIG. 8 shows the next step of removing at least one of the film sticker valves 332 from within the outline 325 to expose a port 322, and leaving the remaining valves 332 within the outline 325 in place. This allows air to be drawn through the port 322 exposed by the film removal. In an alternate embodiment, the dry-erase board 320 may be covered with a layer of film, and the holes 322 could be exposed (opened) by cutting out (or puncturing) the film over them, and the marker 400 would mark just the film, not the board 320. The film could be removed and replaced as needed. This may also work even if the board 320 is incompatible with dry erase. Once too many lines and holes accumulate in the film sheet, it can be replaced with a new board 320.

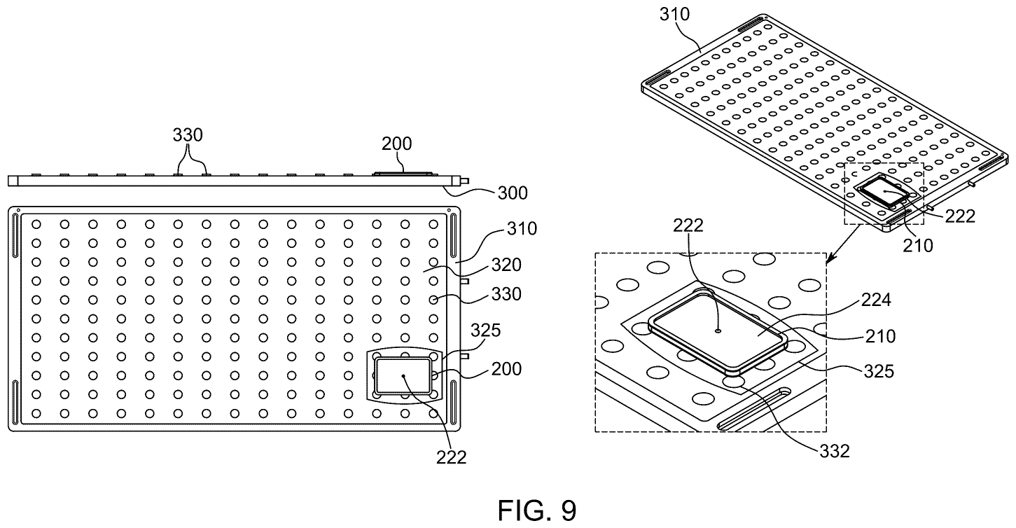

FIG. 9 shows the vacuum pod 200 placement within the outline 325 and over the exposed hole 322. The vacuum pod 200 allows air to be drawn therethrough.

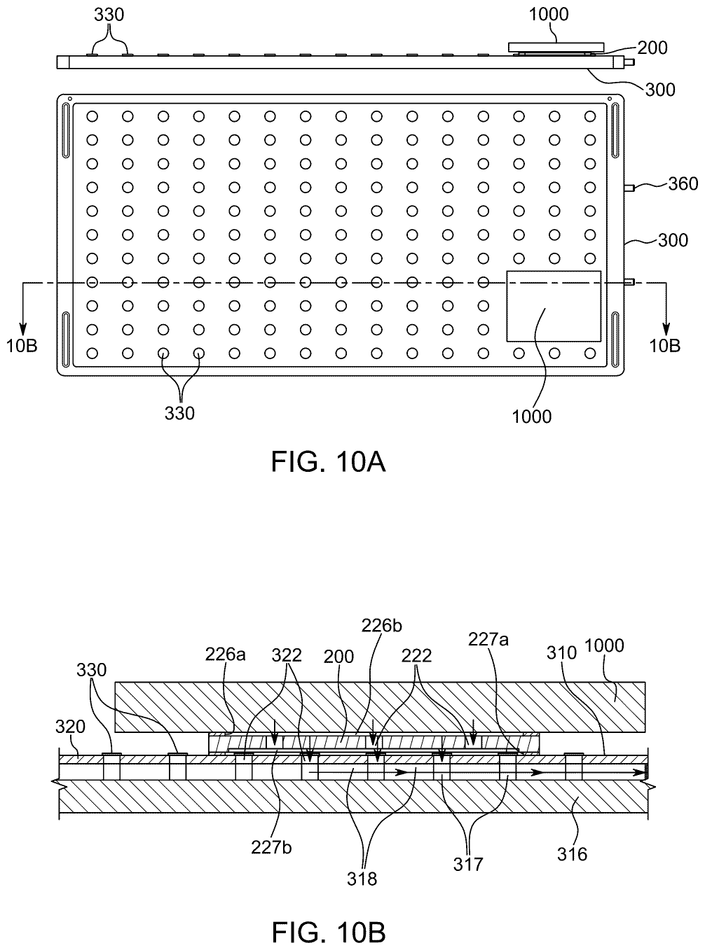

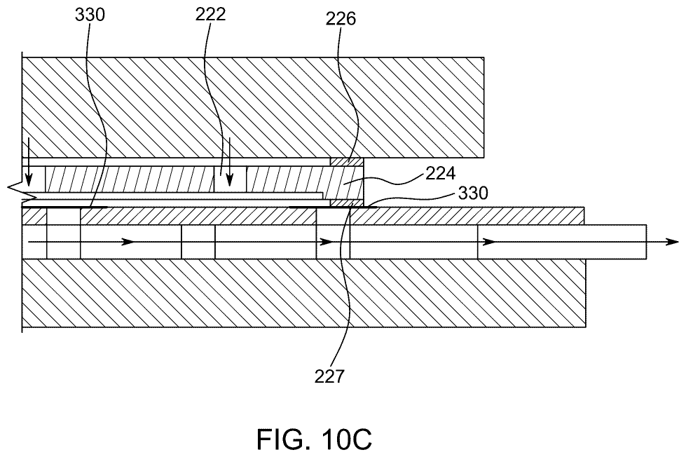

FIG. 10A shows placement of the workpiece 1000 to be machined on top of the vacuum pod 200. Because the workpiece 1000 is raised above the platform base assembly 300, the CNC machine 500, using its machine bits, can work on the workpiece 1000 on its top and sides, and the spacing using the pod 200 even allows for undercuts. In this step, a user can attach a vacuum pump to one of the vacuum ports 315 (with the other port being sealed if not also being used). Taller pods 200 can allow for more significant access to the workpiece's sides and bottom.

FIG. 10B is a cross sectional view through FIG. 10A showing airflow. When the vacuum pump turns on, air flows out of the vacuum port 315. This air flows from an upper air chamber 226b formed between an upper surface of the pod 200 and the workpiece 1000 that are spaced from one other by the upper rim 226a, through the air passages 222 (in this cross-section, three passages through the pod 200 are shown), into a lower air chamber 227b formed between a lower surface of the pod 200 and an upper surface of the dry erase board 320 spaced from one another by the lower rim 227a, through the open ports 322 into the channels 317, around the spaces 318, and eventually out the vacuum port 315.

FIG. 10C is a cross sectional view that shows how a lower gasket 227 may rest on a film valves 330 without disrupting the seal between the valve 330 and port 322. Alternatively, the gasket 227 could be soft enough to seal the port 322 without the need for a valve 330, if the gasket 227 was large enough to cover the port 322.

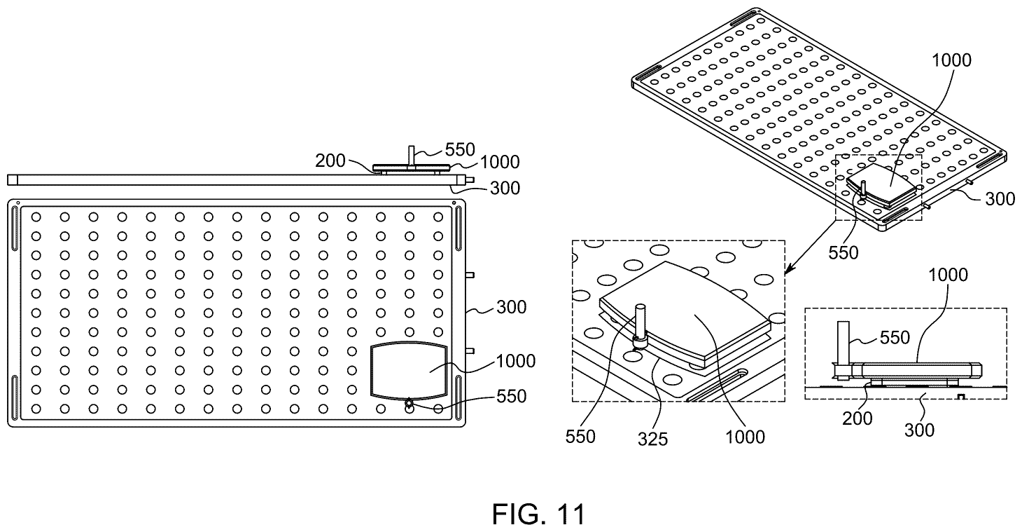

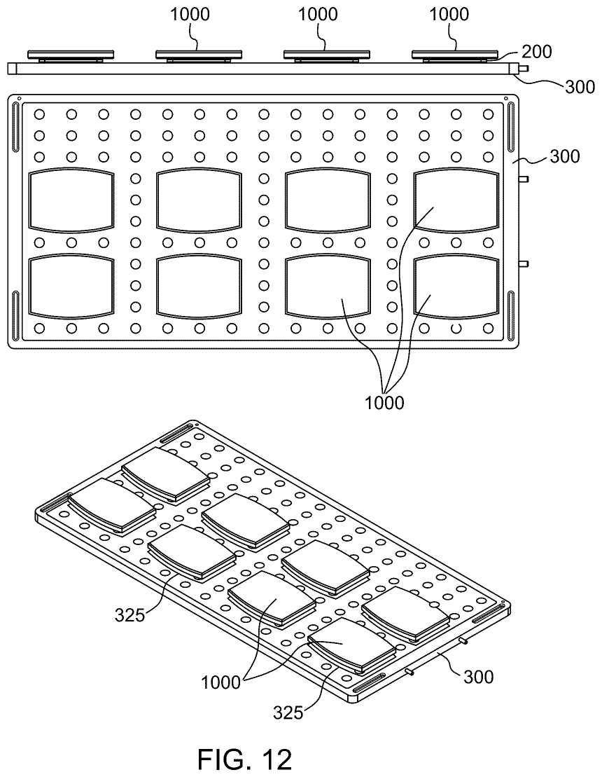

FIG. 11 shows removal of the marker holder assembly 400 and/or introduction of the cutting tools 550 into the control arm 520 on the CNC machine 500. The CNC machine can use the cutting tool 550 to shape the workpiece 1000 according to the CNC programming.

FIG. 12 shows a variation where multiple steps in FIGS. 5-11 have been carried out simultaneously for more efficient mass production. What happens in such a configuration, each workpiece 1000 is mounted on a separate pod 200 above an open port 322, and the CNC can be programmed to shape each workpiece 1000 according to its programming. Although what is shown here are identical workpieces 1000, differently shaped workpieces 1000 with different CNC programming for the ultimate product could be used.

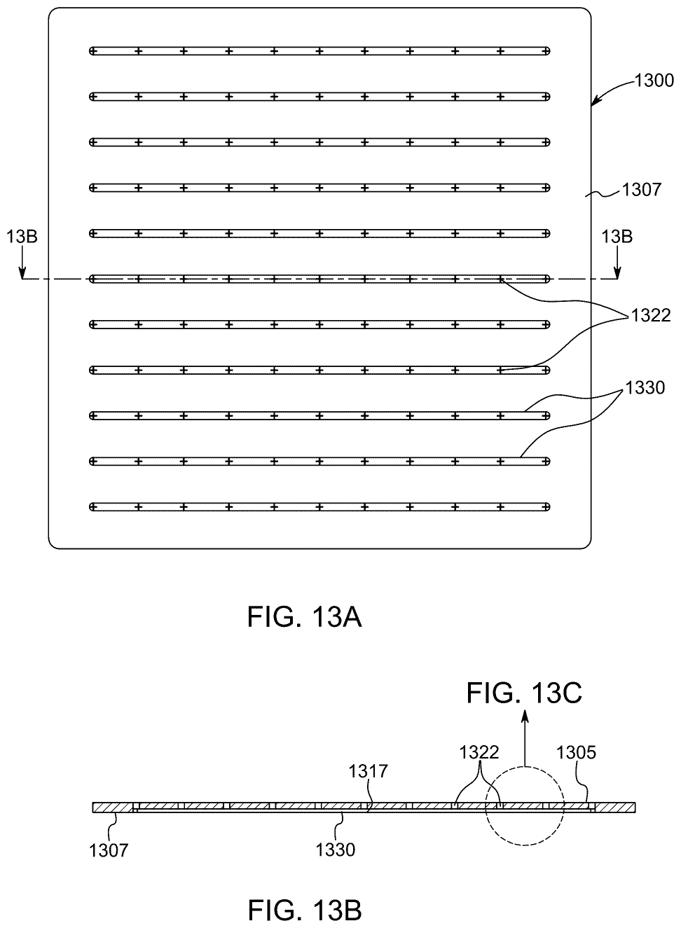

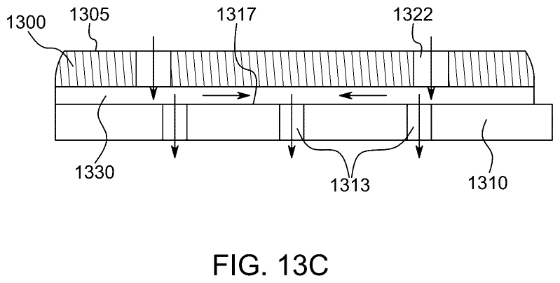

FIGS. 13A-13C show a modular version of a platform base assembly 1300 that can be used with existing vacuum tables 1310 on the market and in the field, including those integral with certain CNC machines. Where the other platform base assembly 300 could be mounted to a CNC work surface using a conventional method such as bolts, clamps, or other connectors, the modular platform base assembly 1300 mounts to the existing vacuum table and may retain all of the functionality previously described: dry erase surface, film valves, and pods.

The modular platform base assembly 1300 may include a dry erase top surface 1305 and a bottom surface 1307 that faces the CNC work surface or other vacuum surface 1317. The modular platform base assembly includes ports 1322 therethrough, with film valves (as previously described) preventing airflow therethrough.

The modular platform assembly 1300 may include air channels 1330 formed into the bottom surface 1307 of the modular platform base assembly, where these channels are in fluid communication with each of the ports 1322 along the channel length. Bottom surface 1307 may seal the modular platform assembly 1300 against the CNC work surface top 1317. Alternatively, the modular platform base assembly may include an overmolded gasket similar to the one used with the vacuum pod to ensure sealing.

When the CNC existing worktable 1310 activates its vacuum, it draws air through open ports 1322 into the air channels 1330, and through the worktable grid channels 1313. Placement of a workpiece 1000 and vacuum pod 200 on the platform base assembly 1300 then replicates what was already described above, with the CNC machine being able to machine the workpiece held securely in place.

The modular platform assembly 1300 may include a vacuum port 1315, which may be capped if the vacuum applied therethrough comes from the CNC vacuum work surface or other vacuum table.

Some alternative embodiments may be possible.

The platform base assembly may be made of any non-porous material of the necessary size/thickness, and dimensional stability may be important. The vacuum may be connected to the system in an indefinite location, and the grid can be milled to any functional pattern or design.
Pods can be custom-cut from various materials into any form necessary. The development will continue here to increase the variety and holding power for more situations. Variations are only constrained by machine size and imagination. Porous pods may be created to hold flexible material where gaskets would cause deformation.
Aftermarket Alignment System—Corresponding tapered pin and tapered holes in the grid base for accurate alignment of origin location and x/y perpendicularity may be used. In order to program accurately, the CNC machine needs an initial datum set to find the origin and ensure parallel/perpendicular installation. This is provided by two tapered holes at predefined locations and a correspondingly tapered pin to use in the control of the CNC system to align base grid for installation.
Alternative Setup—The port board may be swapped out for a dedicated gasketed fixture or a porous spoil-board.
The system may be interchangeable from a “pod” system to a “nested” system using mdf or designated fixtures. The port board can be swapped out for a dedicated fixture or spoil board.
Economical pods and easily applied gasket and shims to control gasket crushing distance for accurate z-axis. (other pod types and gasketing is possible) A surface-applied and adhesive-backed gasket is not common due to the variation in “z-height” when the pod is under load from the vacuum and the gasket is compressed. In order to use this most economical method in operations with critical z axis measurements, multiple rubber or plastic spacers may be placed within the gasketed area to mediate the compression distance of the gasket.
“Porous pods” for flexible materials This may be smaller spoil-boards used as individual pods. This avoids a potential issue where thin and flexible sheet goods can distort when under suction of a normal gasketed pod.
Modular installation for larger machines.
Having platform machined with the spindle on a particular CNC router provides the best surface flatness and integration of other features. Although it is unnecessary and could not be done if the system would be used on (for example) a machine bed for a robotic sanding arm. Making the grid base from aluminum alleviates some of the concerns but also creates economic and other constraints.

While the invention has been described with reference to the embodiments above, a person of ordinary skill in the art would understand that various changes or modifications may be made thereto without departing from the scope of the claims.

1. A pod system configured for use with a CNC machine comprising:
a grid and pod platform base assembly configured for attachment to a vacuum system and capable of drawing air therethrough to create a vacuum;
a vacuum pod configured to engage the grid and pod platform base assembly; and
and a marker holder assembly configured to hold a marker and mark the grid and platform base assembly with an outline in a desired shape.

2. The pod system of claim 1, wherein the grid and pod platform base assembly includes holes therethrough, wherein the holes are in fluid communication with a vacuum source, wherein the holes are open or closed using valves.

3. The pod system of claim 2, wherein the valves are film, and when the film covers the holes, the holes cannot draw air therethrough, and when the film is removed from the holes, the holes can draw air therethrough.

4. The pod system of claim 2, wherein the valves are substantially flush with the pod base surface.

5. The pod system of claim 2, wherein the surface of the grid and pod base assembly material is a dry erase surface.

6. The pod system of claim 2, wherein the holes conduct the vacuum through the valves, which permits placement of vacuum pods and z-axis positioning.

7. The pod system of claim 6, wherein the holes are connected on an underside of the grid and pod base assembly through a channel, wherein this connection is configured to make the grid and pod base assembly to be compatible with different-sized CNC machines.

8. The pod system of claim 1, wherein the marker holder assembly is configured to be driven by a CNC machine and the CNC machine directs the marker holder assembly to draw the outline.

9. The pod system of claim 1, further comprising a workpiece that is mounted on the vacuum pod, wherein the workpiece is held against the vacuum pod and grid and pod platform base assembly when the vacuum is activated.

10. The pod system of claim 8, wherein the CNC machine is configured to machine the workpiece once the workpiece is held against the vacuum pod.

11. A platform base assembly configured for use in CNC machines, comprising:
a platform base assembly configured to be in fluid communication with a vacuum source, wherein the platform base assembly includes a plurality of ports therethrough, wherein the ports are opened and closed by valves, wherein the ports are in fluid communication with the vacuum source, wherein the platform base assembly has channels in a bottom surface whereof, wherein the channels are in fluid communication with one or more port the ports, wherein the bottom surface is configured to engage a vacuum table upper surface, wherein the vacuum table includes the vacuum source.

12. The platform base assembly of claim 11, further comprising a vacuum pod configured to engage the platform base assembly, wherein each vacuum pod includes gaskets for creating a seal against the platform base and configured to produce a seal against a workpiece, wherein the vacuum pod includes at least one air passage therethrough.

13. The pod system of claim 12, wherein the gaskets include upper and lower rims configured to define an air chamber between the platform assembly and the at least one vacuum pod and a workpiece and the at least one vacuum pod.

14. The pod system of claim 11, wherein the valves are film that can be removed or punctured to expose the ports.

15. The pod system of claim 11, wherein the platform base assembly includes a non-porous dry-erase-compatible surface.

16. The pod system of claim 11, wherein each channel creates an air chamber in the bottom surface of the platform base assembly.

17. A method for securing a workpiece on a CNC machine, comprising:
providing a platform base assembly with ports covered by removable valves;
using a marker holder assembly attached to the CNC machine to draw a predetermined workpiece outline on the platform base assembly;
removing at least one valve within the outline to open at least one port;
placing a vacuum pod over the at least one open vacuum port and within the outline, wherein the vacuum pod has an air passage therethrough in fluid communication with the at least one open vacuum port;
placing a workpiece to be machined on the vacuum pod; and
activating a vacuum source to secure the workpiece against the vacuum pod and the vacuum pod against the platform base assembly.

18. The method of claim 16, wherein the valves are a film layer and the ports are opened by cutting or puncturing the film layer.

19. The method of claim 16, further comprising the CNC machine machining the workpiece.

20. The method of claim 18, wherein there are multiple vacuum pods and workpieces secured to the platform base assembly.
